(19) United States
(12) Patent Application Publication
(10) Pub. No.: US 2018/0038317 A1
(43) Pub. Date: Feb. 8, 2018

(54) GAS FUEL SUPPLY APPARATUS

(71) Applicant: AISAN KOGYO KABUSHIKI KAISHA, Obu-shi (JP)

(72) Inventor: Sadatsugu NAGATA, Aichi-gun (JP)

(73) Assignee: AISAN KOGYO KABUSHIKI KAISHA, Obu-shi (JP)

(21) Appl. No.: 15/645,619

(22) Filed: Jul. 10, 2017

(30) Foreign Application Priority Data
Aug. 5, 2016 (JP) 2016-154424

(51) Int. Cl. F02M 21/02; F16K 31/06

(52) U.S. Cl. CPC F02M 21/0254; F02M 21/0257; F16K 31/0658; F16K 31/0675

(57) ABSTRACT

In a fuel injection apparatus, a movable core includes a large-diameter portion and a small-diameter portion, and a fixed core, includes a large-diameter recessed portion and a small-diameter recessed portion in which the large-diameter portion and the small-diameter portion are respectively slidable. While a coil is energized, a first magnetic circuit is formed allowing a magnetic flux to flow between a large-diameter-portion corner of a large-diameter portion and a large-diameter recessed-portion corner of a large-diameter recessed portion, and a second magnetic circuit is formed allowing a magnetic flux to flow between a small-diameter-portion corner of a small-diameter portion and a small-diameter recessed-portion corner of a small-diameter recessed portion.

### CROSS-REFERENCE TO RELATED APPLICATIONS

This application is based upon and claims the benefit of priority from the prior Japanese Patent Application No. 2016-154424 filed on Aug. 5, 2016, the entire contents of which are incorporated herein by reference.

### BACKGROUND

### Technical field

This disclosure relates to a gas fuel supply apparatus incorporating a linear solenoid to regulate a flow rate of gas fuel to be supplied from a fuel container to a supply destination.

### Related Art

As one of gas fuel supply apparatus, conventionally, there is an apparatus that incorporates a linear solenoid to regulate a flow rate of gas fuel to be supplied from a fuel container to a supply destination. The linear solenoid used in such an apparatus is for example disclosed in Patent Document 1. This linear solenoid is provided with a coil, a fixed core, a movable core to be attracted to a fixed core by energization of the coil, a yoke surrounding an outer circumference of the movable core and the fixed core, and a bearing slidably supporting the movable core. In the fuel supply apparatus, the linear solenoid operates to change the distance of a valve element provided at an end of the movable core from a valve seat, i.e. the dimension of a gap between the valve seat and the valve element, to adjust an opening degree in order to regulate a flow rate of gas fuel.

### RELATED ART DOCUMENTS

### Patent Documents

JP 2010-267749A

### SUMMARY

### Technical Problems

However, when a linear solenoid is incorporated in a gas fuel supply apparatus, this apparatus needs a large valve-opening force for valve opening. In other words, when a load acting in a valve closing direction is generated by the pressure of gas fuel, that is, under the influence of gas fuel pressure, a large electromagnetic attraction force is required to move the movable core in a valve opening direction. Reversely, when a load acting in the valve opening direction is generated by the pressure of gas fuel, a load of a compression spring for urging the movable core in the valve closing direction needs to be set large and thus a large electromagnetic attraction force is required to move the movable core in the valve opening direction. In particular, for high-pressure gas fuel, the valve-opening force needs to be set remarkably high. Therefore, the linear solenoid simply applied as in the conventional art could not generate sufficient magnetic attraction force, leading to deterioration in valve-opening property. It is to be noted that upsizing of a coil may increase the magnetic attraction force, but this causes a problem with an increase in size of the gas fuel supply apparatus itself.

This disclosure has been made to address the above problems and has a purpose to provide a gas fuel supply apparatus capable of achieving an improved valve-opening property without any increase in overall size even when a linear solenoid is incorporated therein.

### Means of Solving the Problems

To achieve the above-mentioned purpose, one aspect of the present disclosure provides a gas fuel supply apparatus comprising: a linear solenoid section including: a coil; a fixed core; a movable core to be attracted to the fixed core when the coil is energized a spring urging the movable core in a direction away from the fixed core; a pair of hearings slid ably supporting the movable core at both ends in an axial direction of the movable core; and a yoke covering the coil; a valve element to be operated by the linear solenoid section to move together with the movable core; a housing; and a valve seat fixed to the housing, the fuel supply apparatus being configured to change a distance between the valve element and the valve seat to regulate a flow rate of gas fuel, wherein the movable core includes a large-diameter portion and a small-diameter portion, wherein the fixed core includes a large-diameter recessed portion in which the large-diameter portion is slidable and a small-diameter recessed portion in which the small-diameter portion is slidable, wherein when the coil is energized, a first magnetic circuit is formed allowing a magnetic flux to flow between a large-diameter-portion corner that is a corner of the large-diameter portion and a large-diameter recessed-portion corner that is a corner of the large-diameter recessed portion, and a second magnetic circuit is formed allowing a magnetic flux to flow between a small-diameter-portion corner that is a corner of the small-diameter portion and a small-diameter recessed-portion corner that is a corner of the small-diameter recessed portion.

In the aforementioned gas fuel supply apparatus, when the coil is energized, the two magnetic circuits are formed in the linear solenoid section. Specifically, there are formed the first magnetic circuit in which a magnetic flux flows between the large-diameter-portion corner which is the corner of the large-diameter portion in the movable core and the large-diameter recessed-portion corner which is the corner of the large-diameter recessed portion in the fixed core and the second magnetic circuit in which a magnetic flux flows between the small-diameter-portion corner which is the corner of the small-diameter portion in the movable core and the small-diameter recessed portion corner which is the corner of the small-diameter recessed portion in the fixed core. In each of the first magnetic circuit and the second magnetic circuit; a magnetic attraction force is generated to attract the movable core toward the fixed core. Therefore, the linear solenoid section can be designed with enhanced magnetic attraction force to attract the movable core without increasing the size of a coil. This can achieve an improved valve opening property without any increase in size of the gas fuel supply apparatus even provided with a linear solenoid.

### BRIEF DESCRIPTION OF THE DRAWINGS

FIG. 1 is a cross sectional view of a fuel injection apparatus in a first embodiment;

FIG. 2 is a cross sectional view to explain a first magnetic circuit and a second magnetic circuit;

FIG. 3 is a cross sectional view of a fuel injection apparatus in a second embodiment;

FIG. 4 is a cross sectional view of a fuel injection apparatus in a third embodiment;

FIG. 5 is a cross sectional view of a fuel injection apparatus in a fourth embodiment; and

FIG. 6 is a cross sectional view of a modified example of the fourth embodiment.

### DETAILED DESCRIPTION OF THE EXEMPLARY EMBODIMENTS

### First Embodiment

The following embodiments show a gas fuel supply apparatus of the present disclosure, applied to a fuel injection apparatus (an injector) as one of typical examples of this disclosure. This fuel injection apparatus is for example an apparatus mounted in a fuel-cell (hybrid) vehicle and operated to supply gas fuel (e.g., hydrogen gas) to a fuel cell(s) (not shown). Thus, a first embodiment of the fuel injection apparatus will be firstly described below.

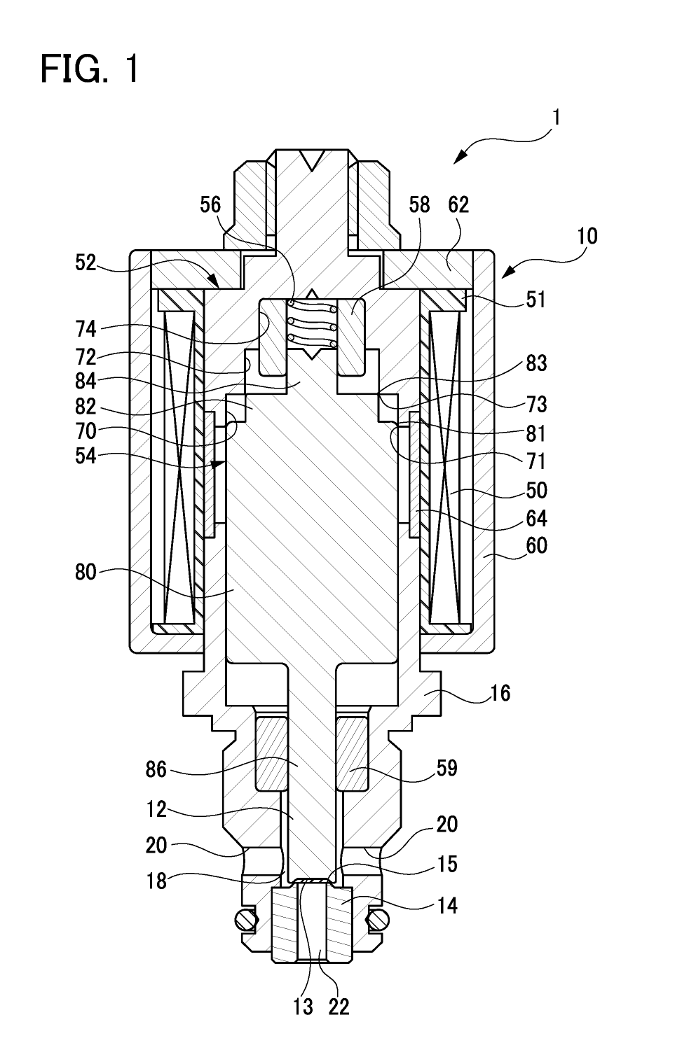

A fuel injection apparatus 1 in the first embodiment includes, as shown in FIG. 1, a linear solenoid section 10, a valve element 12, a valve seat 14, a housing 16, and others.

The linear solenoid section 10 is provided with a coil 50, a fixed core 52, a movable core 54, a compression spring 56, a pair of bearings 58 and 59, a yoke 60, and others. The coil 50 is formed of a wire wound on the outer circumference of a hollow cylindrical coil bobbin 51. In a hollow part of the coil bobbin 51, the fixed core 52 and the movable core 54 are placed.

Specifically, the fixed core 52 is positioned in one end of the coil bobbin 51 in its axial direction. The fixed core 52 has a nearly cylindrical shape (including a perfect circular cylindrical shape, an elliptic cylindrical shape, etc.) and includes a large-diameter recessed portion 70, a small-diameter recessed portion 72, and a bearing-holding recessed portion 74. In other words, the fixed core 52 is formed with three recessed portions arranged stepwise. The large-diameter recessed portion 70 and the small-diameter recessed portion 72 allow the movable core 54 to slide therein. The bearing-holding recessed portion 74 has a smaller diameter than the small-diameter recessed portion 72 and holds therein the bearing 58. The fixed core 52 is made of soft magnetic material (e.g., electromagnetic stainless steel).

The movable core 54 has a nearly cylindrical shape (including a perfect circular cylindrical shape, an elliptic cylindrical shape, etc.) and includes a large-diameter portion 80, a small-diameter portion 82, a shaft portion 84, and a valve element portion 86. The movable core 54 is made of soft magnetic material (e.g., electromagnetic stainless steel). The movable core 54 is positioned so that a part of the large-diameter portion 80 and the valve element portion 86 are placed in the housing 16 and the shaft portion 84 is inserted in the bearing 58. Further, the large-diameter portion 80, the small-diameter portion 82, and the shaft portion 84 are located in the hollow part of the coil bobbin 51.

The movable core 54 is configured such that, when the valve element 12 is brought into contact with, or seated on, the valve seat 14 (in a position shown in FIG. 1), a large-diameter-portion corner 81 which is a corner of the large-diameter portion 80 (i.e. a first corner of the movable core 54) is positioned closest to a large-diameter recessed-portion corner 71 which is a corner of the large-diameter recessed portion 70 (i.e. a first corner of the fixed core 52). In this state, furthermore, a small-diameter-portion corner 83 which is a corner of the small-diameter portion 82 (i.e. a second corner of the movable core 54) is positioned closest to a small-diameter recessed-portion corner 73 which is a corner of the small-diameter recessed portion 72 i.e. a second corner of the fixed core 52).

The movable core 54 is supported so that the shaft part 84 at one end is slidable in the hearing 58 and the valve element portion 86 at the other end is slidable in the bearing 59. Thus, the movable core 54 is allowed to move so that the. outer peripheral surface of the large-diameter portion 80 slides along the inner peripheral surface of the large-diameter recessed portion 70, while the outer peripheral surface of the small-diameter portion 82 slides along the inner peripheral surface of the small-diameter recessed portion 72. Further, the valve element 12 is integrally formed at one end of the valve element portion 86. This valve element 12 is thus moved in association with movement of the movable core 54.

The compression spring 56 is placed inside the bearing 58 and between the fixed core 52 and the movable core 54. This compression spring 56 is normally compressed, urging the valve element 12 (the movable core 54 toward the valve seat 14, i.e., in a direction away from the fixed core 52 corresponding to a valve closing direction.

The yoke 60 is placed surrounding the coil 50. An open end of this yoke 60 is closed by a lid member 62. Those yoke 60 and lid member 62 are made of soft magnetic material (e.g., electromagnetic stainless steel) and constitute a casing of the linear solenoid section 10.

The valve element 12 is integrally provided at the end of the valve element portion 86 of the movable core 54. This valve element 12 is placed upstream of the valve seat 14 in a flowing direction of gas fuel. The valve element 12 is provided, at its end face, with a seal member 13 having a nearly circular disc-like shape. This sea member 13 is to be brought into contact with or away from the valve seat 14 (a seat portion 15). The seal member 13 is formed of an elastic body made of rubber, resin, or other materials.

The valve seat 14 is fixed to the housing 16 and provided with the seat portion 15 having a tapered outer shape. The seal member 13 of the valve element 12 is elastically deformed into contact with this seat portion 15, thereby enhancing sealing property during stop of gas fuel supply, i.e. during valve closing. Further, the valve seat 14 is located downstream of the valve element 12 in the gas fuel flowing direction. This valve seat 14 is formed, in its central area, with an outflow port 22. This outflow port 22 is a through hole formed through the valve seat 14 in its axial direction to form a flow passage of gas fuel. The outflow port 22 is connected to a supply destination (e.g. a fuel cell) through a fuel pipe.

The housing 16 has a nearly cylindrical shape and accommodates the valve element 12 (a part of the movable core 54), the valve seat 14, the bearing 59, and others. This housing 16 is made of soft magnetic material (e.g., electromagnetic stainless steel). The housing 16 is formed internally with a fuel passage 18 extending in an axial direction of the housing 16 to allow gas fuel to flow therethrough. The housing 16 is further provided with inflow ports 20 communicating sideways with the fuel passage 18. Specifically, these inflow ports 20 are through holes radially extending through the housing 16 (in the present embodiment, two through holes in diametrically opposite positions) and serve as flow passages for gas fuel. The inflow ports 20 are connected with a fuel container (e.g., a hydrogen cylinder) through a fuel pipe.

A part of the housing 16 (an area in which the large-diameter portion 80 of the movable core 54 is accommodated) is positioned in the other end (an opposite side to the fixed core 52) of the hollow part of the coil bobbin 51. Further, a non-magnetic annular member 64 is placed between an end (an upper end in FIG. 1) of the housing 16 and an end (a lower end in FIG. 1) of the fixed core 52.

Operations (behavior) of the fuel injection apparatus 1 will be described below. While the coil 50 is not energized, that is, during valve closing, the seal member 13 of the valve element 12 is forced into contact with the seat portion 15 of the valve seat 14 by the urging force of the compression spring 56 as shown in FIG. 1. Therefore, the outflow port 22 of the valve seat 14 is disconnected from the fuel passage 18. Thus, gas fuel is not discharged through the outflow port 22 to the outside of the fuel injection apparatus 1.

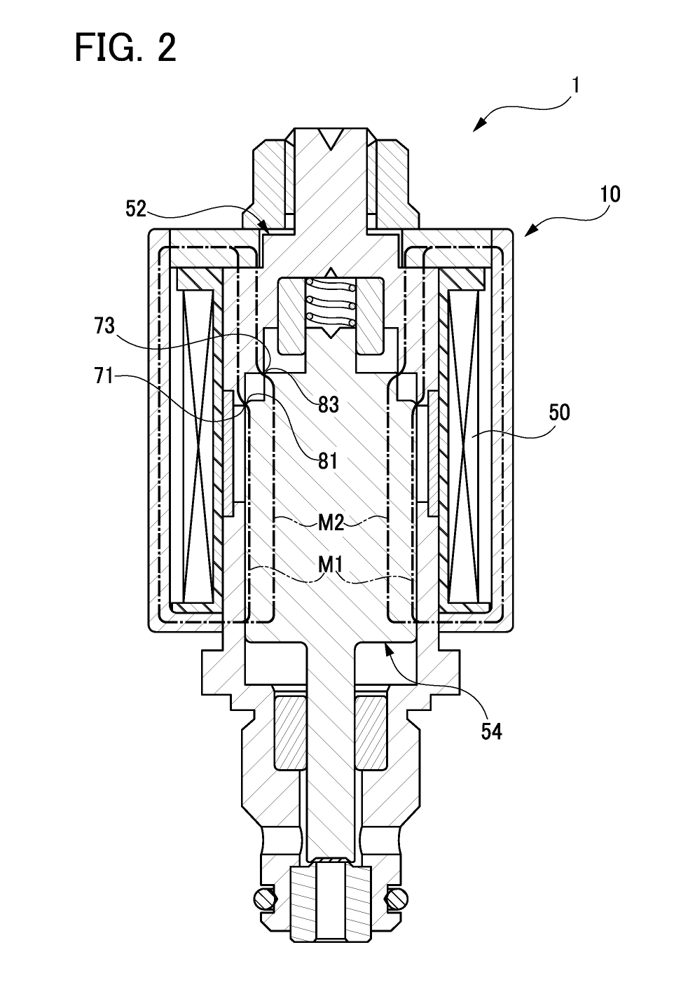

In contrast, when the coil 50 is energized, that is, during valve opening, two magnetic circuits M1 and M2 are formed around the coil 50 to allow magnetic flux to circulate from the yoke 60 through the housing 16, movable core 54, fixed core 52, and lid member 62 and back through the yoke 60. In these two magnetic circuits M1 and M2, the magnetic fluxes flowing between the movable core 54 and the fixed core 52 trace different paths. Specifically, as shown in FIG. 2, the first magnetic circuit M1 is formed allowing a magnetic flux to flow between the large-diameter-portion corner 81 and the large-diameter recessed-portion corner 71 and the second magnetic circuit M2 is formed allowing a magnetic flux to flow between the small-diameter-portion corner 83 and the small-diameter recessed-portion corner 73.

Accordingly, in both the first magnetic circuit M1 and the second magnetic circuit M2, a magnetic attraction force is generated in the fixed core 52 to attract the movable core 54. In the linear solenoid section 10, therefore, a magnetic attraction force to attract the movable core 54 can be increased in strength without any increase in size of the coil 50. This can enhance the valve opening property of the fuel injection apparatus 1 without any increase in size.

At the start of energization, i.e. at the start of valve opening, the large-diameter-portion corner 81 and the large-diameter recessed portion corner 71 are positioned closest to each other and also the small-diameter-portion corner 83 and the small-diameter recessed-portion corner 73 are positioned closest to each other. Accordingly, the magnetic attraction force generated by each of the first magnetic circuit M1 and the second magnetic circuit M2, corresponding to an axial attraction force to attract the movable core 54 in an axial direction, can be maximized. In the linear solenoid section 10, since the axial attraction force to attract the movable core 54 in the axial direction toward the fixed core 52 (i.e. in a valve opening direction) can be increased, the valve opening property of the fuel injection apparatus 1 at the start of valve opening can be improved.

The movable core 54 can thus be reliably moved toward the fixed core 52, which in turn moves the valve element 12 toward the fixed core 52. Accordingly, the seal member 13 of the valve element 12 is separated from the seat portion 15 of the valve seat 14. The outflow port 22 of the valve seat 14 is thus allowed to communicate with the fuel passage 18.

To be concrete, the outflow port 22 is communicated with the fuel passage 18 through a gap between the seal member 13 of the valve element 12 and the seat portion 15 of the valve seat 14. This allows gas fuel flowing in the fuel passage 18 to flow into the outflow port 22 through the gap between the seal member 13 and the seat portion 15. Accordingly, the gas fuel is discharged from the outflow port 22 to the outside of the fuel injection apparatus 1. At that time, a travel distance of the movable core 54 (the valve element 12) is changed according to (proportional to) an amount of current applied to the coil 50. Therefore, the amount of current to be applied to the coil 50 is controlled to adjust an opening degree of the fuel injection apparatus 1 (i.e. a distance, or a gap, between the valve element 12 and the valve seat 14) to thereby regulate an amount of gas fuel to be supplied.

According to the fuel injection apparatus 1 in the present embodiment described in detail above, when the coil 50 is applied with current, two magnetic circuits M1 and M2 are formed in the linear solenoid section 10. That is, the first magnetic circuit M1 is formed allowing a magnetic flux to flow between the is diameter-portion corner 81 of the movable core 54 and the large-diameter recessed-portion corner 71 of the fixed core 52 and the second magnetic circuit M2 is formed allowing a magnetic flux to flow between the small-diameter-portion corner 83 of the movable core 54 and the small-diameter recessed-portion corner 73 of the fixed core 52. In each of the first magnetic circuit M1 and the second magnetic circuit M2, the magnetic attraction force is generated in the fixed core 52 to attract the movable core 54. In the linear solenoid section 10, therefore, a magnetic attraction force to attract the movable core 54 can be increased in strength without any increase in size. This can enhance the valve opening property of the fuel injection apparatus 1.

### Second Embodiment

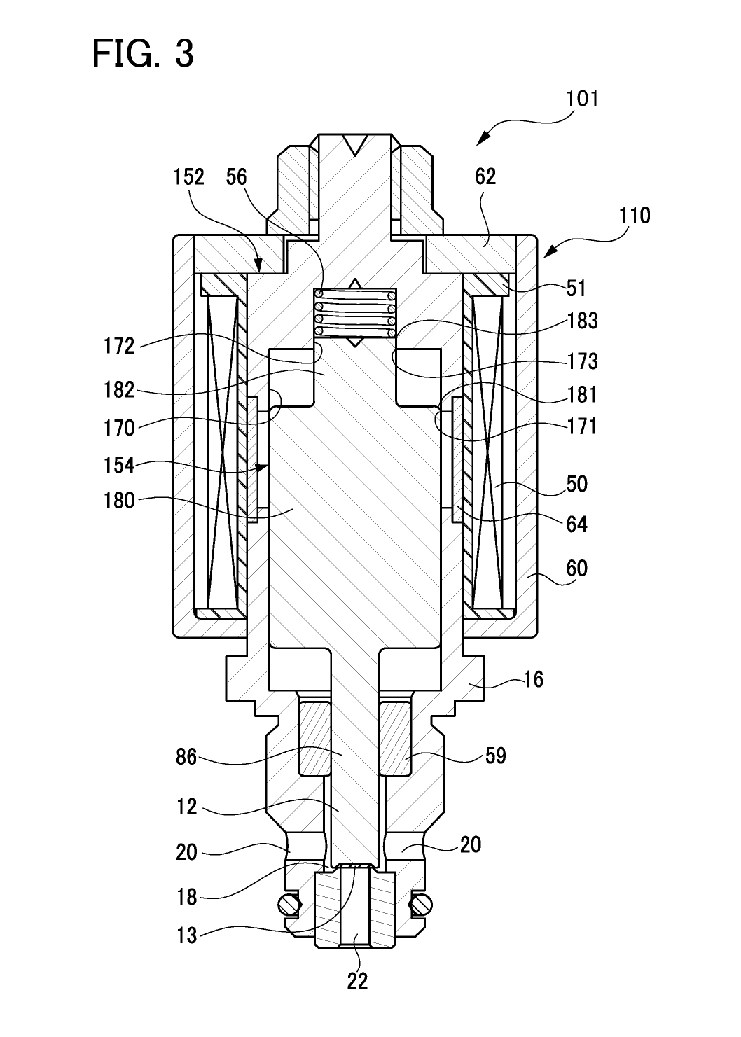

A second embodiment will be described below, referring to FIG. 3. Like parts or components to the first embodiment are designated by same reference numerals and will not be further explained. The following description is therefore made with a focus on differences from the first embodiment.

A fuel injection apparatus 101 in the second embodiment differs from the first embodiment in the shapes of a fixed core 152 and a movable core 154 as shown in FIG. 3. To be concrete, the fixed core 152 is provided with a large-diameter recessed portion 170 and a small-diameter recessed portion 172. In other words, the fixed core 152 is formed with only two recessed portions arranged stepwise. Correspondingly, the movable core 154 is provided with a large-diameter portion 180 a small diameter portion 182, and a valve element 86.

The small-diameter recessed portion 172 also serves as one of the bearings slidably supporting the movable core 154. Specifically, one of the bearings is constituted of the small-diameter recessed portion 172 and provided integral with the fixed core 152. Accordingly, the fuel injection apparatus 101 is reduced in component count by the number of bearings as compared with the fuel injection apparatus 1.

In this fuel injection apparatus 101, when the coil 50 is energized, that is, during valve opening, two magnetic circuits M1 and M2 are formed around the coil 50 to allow magnetic flux to circulate from the yoke 60 through the housing 16, movable core 154, fixed core 152, and lid member 62 and back through the yoke 60. In these o magnetic circuits M1 and M2, the magnetic fluxes flowing between the movable core 154 and the fixed core 152 trace different paths. Specifically, the first magnetic circuit M1 is formed allowing a magnetic flux to flow between a large-diameter-portion corner 181 and a large-diameter recessed-portion corner 171 and the second magnetic circuit M2 is formed allowing a magnetic flux to flow between a small-diameter-portion corner 183 and a small-diameter recessed-portion corner 173. In the linear solenoid section 110, therefore, a magnetic attraction force to attract the movable core 154 can be increased in strength without any increase in size.

According to the fuel injection apparatus 101, consequently, the linear solenoid section 110 can increase the magnetic attraction force to attract the movable core 154 and enhance the valve opening property. The component count can also be reduced.

### Third Embodiment

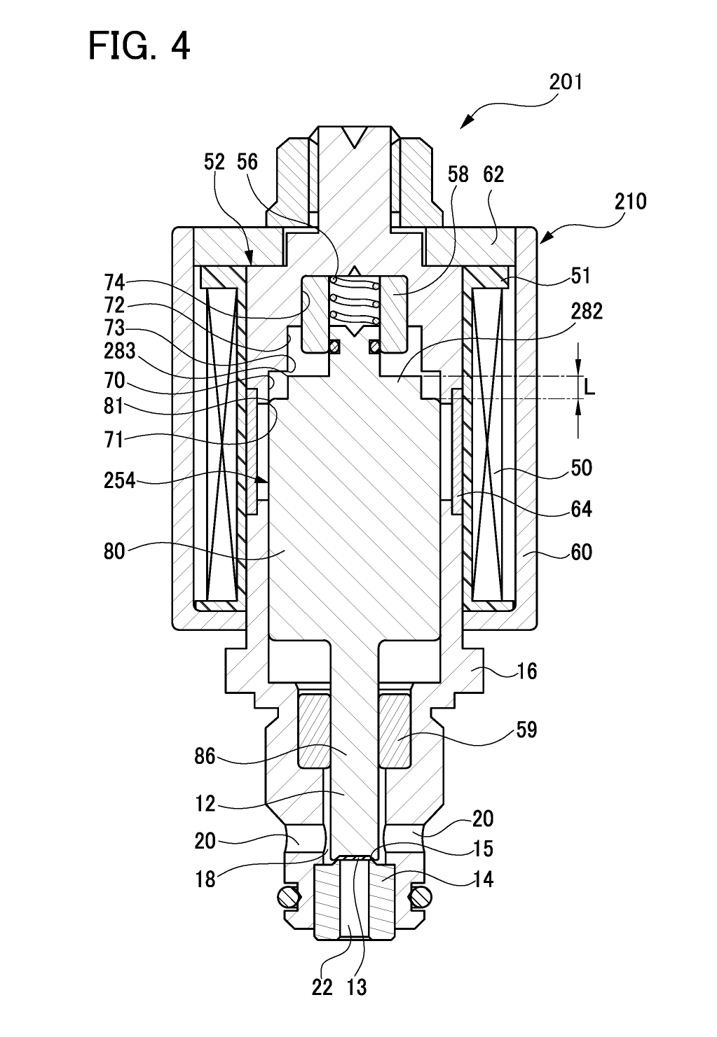

A third embodiment will be described below, referring to FIG. 4. Like parts or components to the first embodiment are designated by same reference numerals and will not be further explained. The following description is therefore made with a focus on differences from the first embodiment.

A fuel injection apparatus 201 in the third embodiment differs from the first embodiment in the shape of a movable core 254 as shown in FIG. 4. To be concrete, the length L of a small-diameter portion 282 in an axial direction in the movable core 254 is shorter (smaller) than that in the first embodiment. While the valve element 12 is in contact with the valve seat 14, accordingly, the small-diameter-portion corner 283 is away from the small-diameter recessed-portion corner 73. Then, when the movable core 254 is moved toward the fixed core 52 by a predetermined distance, the small-diameter-portion corner 283 comes closest to the small-diameter recessed-portion corner 73.

Herein, the axial length L can be set for example based on the predetermined distance determined based on a travel distance of the movable core 254 moved in the valve opening direction at which the axial attraction force generated by the first magnetic circuit M1 to attract the movable core 254 in the axial direction starts declining or weakening. In the present embodiment, the axial length L is set so that, before the axial attraction force generated in the first magnetic circuit M1 starts declining, the small-diameter-portion corner 283 comes closest to the small-diameter recessed-portion corner 73 so that the axial attraction force generated by the second magnetic circuit M2 is maximum.

In this fuel injection apparatus 201, when the coil 50 is energized, that is, during valve opening, two magnetic circuits M1 and M2 are formed around the coil 50 to allow magnetic flux to circulate from the yoke 60 through the housing 16, movable core 254, fixed core 52, and lid member 62, and back through the yoke 60. In these two magnetic circuits M1 and M2, the magnetic fluxes flowing between the movable core 254 and the fixed core 52 trace different paths. Specifically, the first magnetic circuit M1 is formed allowing a magnetic flux to flow between the large-diameter-portion corner 81 and the large-diameter recessed-portion corner 71 and the second magnetic circuit M2 is formed allowing a magnetic flux to flow between the small-diameter-portion corner 283 and the small-diameter recessed-portion corner 73. In a linear solenoid section 210 of the fuel injection apparatus 201, therefore, a magnetic attraction force to attract the movable core 254 can be increased in strength without any increase in size of the linear solenoid section 210. However, the magnetic attraction force of the second magnetic circuit M2 at the start of valve opening is weaker than in the first embodiment.

According to the fuel injection apparatus 201, consequently, the magnetic attraction force attracting the movable core 254 at the start of valve opening is lower than in the first embodiment but is larger than in the conventional art. Thus, the valve opening property can be enhanced.

As the current to be applied to the coil 50 is gradually increased and accordingly the movable core 254 is moved toward the fixed core 52, in the first magnetic circuit M1, a radial attraction force attracting the movable core 254 in a radial direction becomes higher and then, before the axial attraction force attracting the movable core 254 in an axial direction in the first magnetic circuit M1 starts declining, the axial attraction force attracting the movable core 254 in the second magnetic circuit M2 can be maximized.

According to the fuel injection apparatus 201, therefore, the travel distance (the movable range) of the movable core 254 in a proportional region (a control area) of the linear solenoid section 210 can be set large. This makes it possible to improve controllability at the valve opening, thus enabling controlling the amount of gas fuel to be supplied with high precision.

### Fourth Embodiment

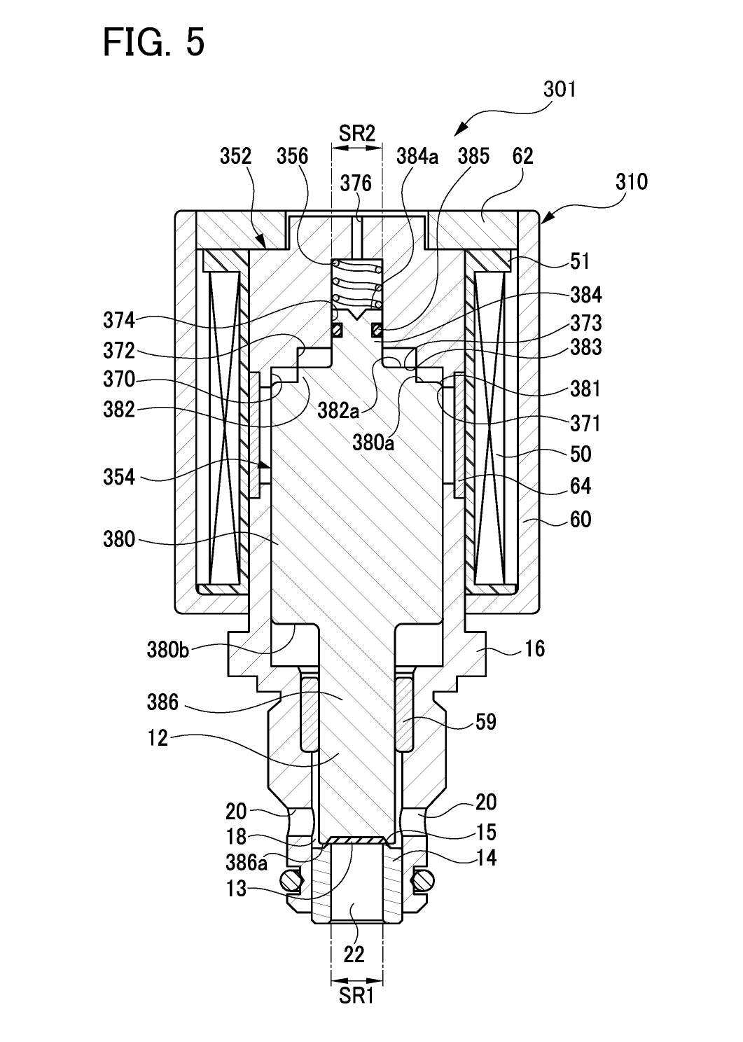

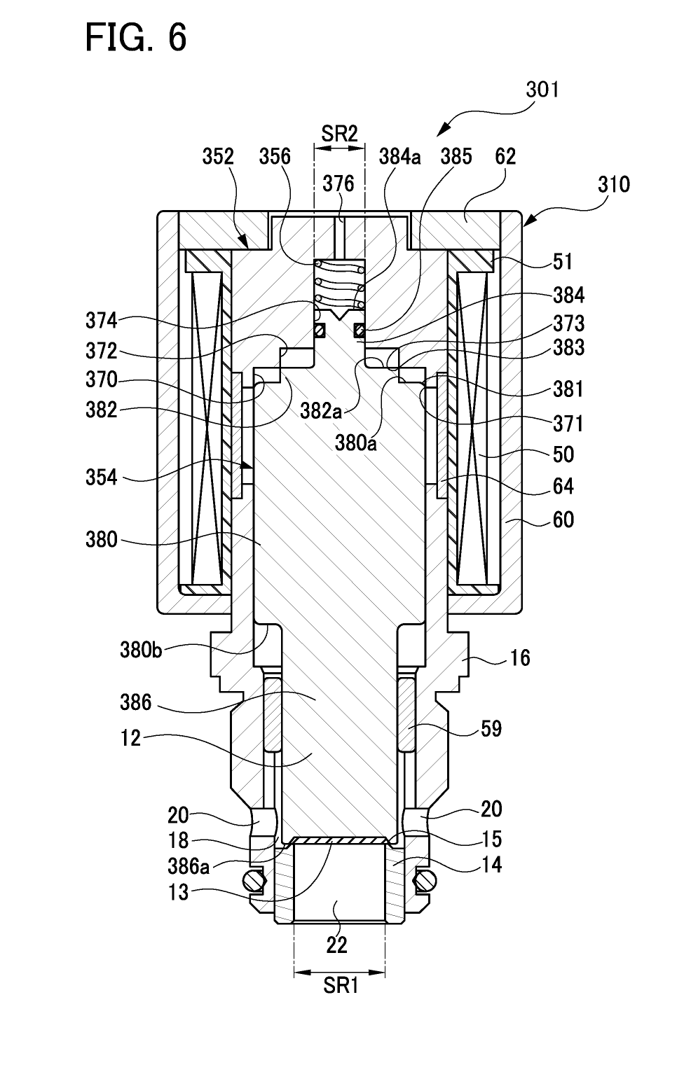

A fourth embodiment will be described below, referring to FIGS. 5 and 6. Like parts or components to the first embodiment are designated by same reference numerals and will not be further explained. The following description is therefore made with a focus on differences from the first embodiment.

A fuel injection apparatus 301 in the fourth embodiment differs from that in the first embodiment in the shapes of a fixed core 352 and a movable core 354 as shown in FIG. 5. To be concrete, the fixed core 352 is provided with a large-diameter recessed portion 370, a small-diameter recessed portion 372, a bearing recessed portion 374, and a through hole 376 allowing the bearing recessed portion 374 to communicate with outside. Correspondingly, the movable core 354 is provided with a large-diameter portion 380, a small-diameter portion 382, a shaft portion 384, and a valve element portion 386.

Herein, the shaft portion 384 is provided with an annular seal member 385 (e.g., an O ring) for sealing against the fixed core 352 (the bearing recessed portion 374). Further, an area of the bearing recessed portion 374 in which the compression spring 356 is placed is communicated with the outside through the through hole 376. Accordingly, the pressure of gas fuel (primary pressure) does not act on an end face 384a of the shaft portion 384.

A sealing diameter SR1 (corresponding to an inner diameter of the seat portion 15) defined by the seal member 13 of the valve element 12 brought into contact with, or seated on, the seat portion 15 of the valve seat 14, thus sealing off the outflow port 22, is equal to a sealing diameter SR2 of the annular seal member 385 (corresponding to an outer diameter of the annular seal member 385) (SR1=SR2). Accordingly, the pressure-receiving area of the movable core 354 to be subjected to the pressure of gas fuel (primary pressure) acting in the valve closing direction (that is, a total area of the end face 380a of the large-diameter portion 380 and the end face 382a of the small-diameter portion 382 located close to the fixed core 352) is equal to the pressure-receiving area of the movable core 354 to be subjected to the pressure of gas fuel (primary pressure) acting in the valve opening direction (that is, a total area of the end face 380b of the large-diameter portion 380 located close to the valve element portion 386 and a part of the end face 386a of the valve element portion 386 more outside than the seat portion 15 (the outflow port 22)). Consequently, the force generated by the gas fuel pressure (primary pressure) urging the movable core 354 (the valve element 12) in the valve closing direction can disappear (be balanced out).

Not only when the sealing diameter SR1 is equal to the sealing diameter SR2, but also even when the sealing diameter SR1 is larger than the sealing diameter SR2 (SRI>SR2) as shown in FIG. 6, the force generated by the gas fuel pressure (primary pressure) urging the movable core 354 (the valve element 12) in the valve closing direction can be reduced as compared with those in other embodiments. In this case, specifically, the pressure-receiving area of the movable core 354 to be subjected to the gas fuel pressure (primary pressure) acting in the valve closing direction (that is, a total area of the end face 380a of the large-diameter portion 380 and the end face 382a of the small-diameter portion 382 each located close to the fixed core 352) is larger than the pressure-receiving area of the movable core 354 to be subjected to the gas fuel pressure (primary pressure) acting in the valve opening direction (that is, a total area of the end face 380b of the large-diameter portion 380 and the valve element portion 386 and a part of the end face 386a of the valve element portion 386 more outside than the seat portion 15 (the outflow port 22)). Consequently, the seal member 13 can be pressed against the seat portion 15 by use of the gas fuel pressure (primary pressure), so that a set load of the compression spring 356 can be reduced as compared with those in other embodiments.

In the fuel injection apparatus 301 configured as above, when the coil 50 is energized, that is, during valve opening, two magnetic circuits M1 and M2 are formed around the coil 50 to allow magnetic flux to circulate from the yoke 60, through the housing 16, movable core 354, fixed core 352, and lid member 62, and back through the yoke 60. In these two magnetic circuits M1 and M2, the magnetic fluxes flowing between the movable core 354 and the fixed core 352 trace different paths. Specifically, the first magnetic circuit M1 is formed allowing a magnetic flux to flow between the large-diameter-portion corner 381 and the large-diameter recessed-portion corner 371 and the second magnetic circuit M2 is formed allowing a magnetic flux to flow between the small-diameter-portion corner 383 and the small-diameter recessed-portion corner 373. In the linear solenoid section 310, therefore, a magnetic attraction force to attract the movable core 354 can be increased in strength without any increase in size of the linear solenoid section 310.

According to the fuel injection apparatus 301, consequently, the force generated by the gas fuel pressure (primary pressure), urging the movable core 354 (the valve element 12) in the valve closing direction, is balanced out (or reduced) and thus the magnetic attraction force to attract the movable core 354 is increased. This can make it possible to reliably enhance the valve opening property.

The foregoing embodiments are mere examples and give no limitation to the present disclosure. The present disclosure may be embodied in other specific forms without departing from the essential characteristics thereof. For instance, the aforementioned fuel injection apparatus can also be directed to gas fuel (e.g. CNG) other than hydrogen.

The aforementioned embodiment describes the case where gas fuel flows from the inflow port 20 to the outflow port 22 via the fuel passage 18. As an alternative, the present disclosure is applicable to a reverse direction of gas fuel, that is, to a case where gas fuel flows from the inflow port 20 to the outflow port 22 via the fuel passage 18.

### REFERENCE SIGNS LIST

1 Fuel injection apparatus

10 Linear solenoid section

12 Valve element

13 Seal member

14 Valve seat

15 Seat part

16 Housing

50 Coil

52 Fixed core

54 Movable core

56 Compression spring

58 Bearing

59 Bearing

60 Yoke

70 Large-diameter recessed portion

71 Large-diameter recessed-portion corner

72 Small-diameter recessed portion

73 Small-diameter recessed-portion corner

80 Large-diameter portion

81 Large-diameter portion corner

82 Small-diameter portion

83 Small-diameter portion corner

M1 First magnetic circuit

M2 Second magnetic circuit

What is claimed is:

1. A gas fuel supply apparatus comprising:
a linear solenoid section including:
a coil;
a fixed core;
a movable core to be attracted to the fixed core when the coil is energized;
a spring urging the movable core in a direction away from the fixed core;
a pair of bearings slidably supporting the movable core at both ends in an axial direction of the movable core; and
a yoke covering the coil;
a valve element to be operated by the linear solenoid section to move together with the movable core:
a housing; and
a valve seat fixed to the housing,
the fuel supply apparatus being configured to change a distance between the valve element and the valve seat to regulate a flow rate of gas fuel,
wherein the movable core includes a large-diameter portion and a small-diameter portion,
wherein the fixed core includes a large-diameter recessed portion in which the large-diameter portion is slidable and a small-diameter recessed portion in which the small-diameter portion is slidable,
wherein when the coil is energized,
a first magnetic circuit is formed allowing a magnetic flux to flow between a large-diameter-portion corner that is a corner of the large-diameter portion and a large-diameter recessed-portion corner that is a corner of the large-diameter recessed portion, and
a second magnetic circuit is formed allowing a magnetic flux to flow between a small-diameter-portion corner that is a corner of the small-diameter portion and a small-diameter recessed-portion corner that is a corner of the small-diameter recessed portion.

2. The gas fuel supply apparatus according to claim 1, wherein one of the bearings is constituted of the small-diameter recessed portion and integrally provided with the fixed core.

3. The gas fuel supply apparatus according to claim 1, wherein
when the valve element is in contact with the valve seat, the large-diameter-portion corner is positioned closest to the large-diameter recessed-portion corner and the small-diameter-portion corner is positioned closest to the small-diameter recessed-portion corner.

4. The gas fuel supply apparatus according to claim 1, wherein
when the valve element is in contact with the valve seat, the large-diameter-portion corner is positioned closest to the large-diameter recessed-portion corner, and
when the movable core is moved toward the fixed core by a predetermined distance, the small-diameter-portion corner comes closest to the small-diameter recessed-portion corner.

5. The gas fuel supply apparatus according to claim 1, further including an annular seal member provided in the movable core to seal between the movable core and the fixed core,
wherein a sealing diameter defined by the valve element brought into contact with the valve seat is equal to or larger than a sealing diameter of the annular seal member.
